(19) United States
(12) Patent Application Publication
(10) Pub. No.: US 2011/0289416 A1
(43) Pub. Date: Nov. 24, 2011

(54) Screensaver System and Method for Providing Content to Users and Workstations

(76) Inventors: Andre Godfrey, Pittsford, NY (US); Josiah Hennard, Rochester, NY (US); Jonathan Woschanko, Rochester, NY (US); Douglas C. Crawford, Fairport, NY (US)

(21) Appl. No.: 13/113,564

(22) Filed: May 23, 2011

Related U.S. Application Data
(60) Provisional application No. 61/347,593, filed on May 24, 2010.

(51) Int. Cl. G06F 3/00; G06F 15/16

(52) U.S. Cl. 715/733

(57) ABSTRACT

A system and method for providing personal computing device screensaver content from a central server, the system further utilizing membership in Active Directory groups to control the screensaver content, enabling screensavers to be remotely enabled for immediate display of urgent messages, utilizing distributed relay services to minimize public internet traffic in the distribution of content to workstations, providing the display of or interaction with a website within a screensaver, providing acknowledgement of displayed information by a user to build an audit trail, and centrally controlling the length of time that information is displayed on selective screensavers and to end users.

### CROSS-REFERENCE TO RELATED APPLICATIONS

This application claims the benefit of U.S. Provisional Patent Application No. 61/347,593, filed on May 24, 2010. The contents of U.S. Provisional Patent Application No. 61/347,593 are hereby incorporated by reference in its entirety.

### FIELD OF THE INVENTION

The present invention generally relates to a system and method for providing a centralized and integrated real-time communication mechanism for propagating content to the displays of several connected client devices or the individual users that logon to such devices. Presentations, images and webpage content are provided as screensavers for any number of computing devices and/or select groups of users from a centralized system. The screensaver may also be interactive.

### BACKGROUND OF THE INVENTION

Communication to members of an organization is essential to the operations, success and mission of the organization. Typically, various methods and modes of communication are embraced and utilized within every organization such as, electronic mail (email), telephones, instant messaging, intranet sites, memorandums, and so on. The larger the organization, the more varied and widespread the communication requirements and the more tedious the efforts become. Even more challenging in today's society is the advent of telecommuting and the disparate locations around the globe from which several employees, contractors and/or agents of an organization may be operating.

The traditional communication mechanisms currently utilized by private companies and/or government entities have a number of drawbacks. For example, a drawback to email, is that this mode can be easily ignored due to the volume of emails that flood a user's inbox, sometimes making it difficult to discern critical matters. Email may also inadvertently be deleted or otherwise characterized as spam or junk mail, and as a result, the email is never seen by the intended recipient.

Telephones are another widespread communication tool. However, in the case of a large organization, getting information out to a large number of employees by telephone would be very time consuming and ineffective. Using voicemail and some automated delivery system might work, but there are sometimes too many messages in a user's voicemail box such that a user may choose not to sift through them, or worse yet, the voicemail box may be full and therefore not accept any new messages. Further, it may also be time consuming for the recipient to listen to a number of messages, particularly long messages. Even further, a verbal message is potentially subject to misunderstanding and misinterpretation.

In some instances, Intranet sites are utilized as a way to provide “in-house” information to organization members. The problem with this method of information dissemination is that it is particularly tedious to get users to habitually surf the Intranet site or to navigate the site correctly. As such, pertinent information may go unseen.

In essence, current inter-organization processes are cumbersome, inefficient and inflexible. Furthermore, the processes previously mentioned require a significant amount of time to make modifications and edits to the information or content that is to be delivered, and more importantly, limit the nature of the communication depending on the medium that is implemented. To address some of these short comings, the concept of information dissemination and communication have evolved within the computing industry. Texting, tweeting, and instant messaging, to name a few, have become mainstream modes of communication because of their speed and wide reach. However, these methods also have their drawbacks in that types of information that can be transmitted through such mediums are quite limited. For example, graphics, web page content, images, or other rich content cannot be disseminated by such mediums.

What is needed is a robust, adaptable, efficient, and user-friendly tool and technique for providing centralized dissemination of a wide variety of content in a consistent and uniform manner to one or more users and computing devices via screensavers. The present invention fills these as well as other needs.

### SUMMARY OF THE INVENTION

In order to overcome the above stated problems, the present invention provides a system for presenting screensaver content to devices from a central system, the system comprising a content server having screensaver content stored thereon, a relay service, and one or more workstations that each have a display for presenting content to a user. The workstation, relay service and content server are in operable communication on a network. The relay service operably communicates with the content server to receive the screensaver content and subsequently provides the screensaver content to the one or more workstations for display thereon.

Additional benefits of the above described system and method for providing screensaver content from a centralized system are set forth in the following discussion.

### BRIEF DESCRIPTION OF THE DRAWINGS

The above-mentioned and other features and advantages of this invention, and the manner of attaining them, will become apparent and be better understood by reference to the following description of the invention in conjunction with the accompanying drawings, wherein:

FIG. 1 is a block diagram that generally illustrates a networking environment in which the present invention and the components thereof may be utilized;

FIG. 2 is a block diagram generally illustrating the workstation component of the present invention and components thereof;

FIG. 3A is a flow diagram of exemplary messaging between the master loader and the relay service component of the present invention;

FIG. 3B is a flow diagram of an exemplary communication between the master loader and the screensaver component of the present invention;

FIG. 3C is a flow diagram of an exemplary main loop for the master loader component of the present invention;

FIG. 4 is a flow diagram of an exemplary implementation of the client loader component of the present invention;

FIG. 5 is a flow diagram of an exemplary implementation of the screensaver component of the present invention; and

FIG. 6 is a block diagram generally illustrating a computing environment in which the various aspects of the present invention may be implemented.

### DETAILED DESCRIPTION OF THE INVENTION

Generally, the systems and methods described herein for creating and implementing an integrated communication mechanism and screensaver can be implemented with varying combinations of hardware and/or software.

This document is organized as follows: in the first section, an overview of the techniques and implementation is provided and described. In the next section, an exemplary implementation environment to which the present invention would be applicable is discussed to provide context for the present invention. Following that, various component modules of the system are described. Finally, an exemplary computing environment in which the present invention may be implemented and utilized is described.

### Overview of Techniques and Implementation

The present invention can be thought of in the context of an integrated real-time communication mechanism operating as a sophisticated screensaver, wherein messages or varieties of information from one or more sources may be propagated to the displays of several connected devices, for display and/or interaction by the users of said devices. The content for the screensaver may comprise one or more slides of information.

In the described embodiment of the present invention, the system provides a personal computing device (PC) based screensaver content from a central server; utilizes membership in Active Directory groups to control the screensaver content; enables client device screensavers and/or user screensavers to be remotely enabled for immediate display of urgent messages, thereby bypassing traditional screensaver timeout; operates in multiple modes based on commands from a central server; utilizes distributed relay services to minimize public internet traffic in the distribution of content to workstations; enables the display of, or interaction with, a website within a screensaver under the control of a central server; centrally selects website targets that are displayed when a user clicks on a screensaver image; enables acknowledgement of displayed information by a user and provides an audit trail of same; provides a mechanism to convert presentations and images into a form that can be broadcast to selected PCs and displayed on their screensavers; and centrally controls how long information is displayed on selective PC screensavers.

### Exemplary Implementation Environment

A hospital, having exhausted traditional avenues for achieving widespread compliance with hand hygiene guidelines, sought to find an unconventional approach for effecting behavioral change. Traditional methods of trying to encourage proper hand hygiene did not work, so the hospital's administration decided to consider a non-traditional approach. Rather than just telling or reminding staff members of the need/benefits of hand hygiene, a decision was made to feature images of the “disgusting and striking” bacteria revealed by cultures. The images were featured by posting pictures of the bacteria all over the hospital walls. However, patients and other hospital visitors also had to endure these images and such impressions were not in the best interest of the hospital's public relation image. As such, a more private yet persistent way of conveying the message was sought. All hospital staff at one point or another utilize computer systems, either just for time keeping purposes, or as an integral part of their job functions, including record keeping, research, patient file access, etc. As such, placing images of bacteria on the computers in the hospital would provide wide proliferation of the images. In such a scenario, the present invention provides a centralized source for disseminating those images to the computers, minimizes the need to touch every workstation each time there is a change in the information that is to be displayed, and provides all of the other benefits and features that are described later in this document.

### System Modules and Exemplary Embodiment of the Invention

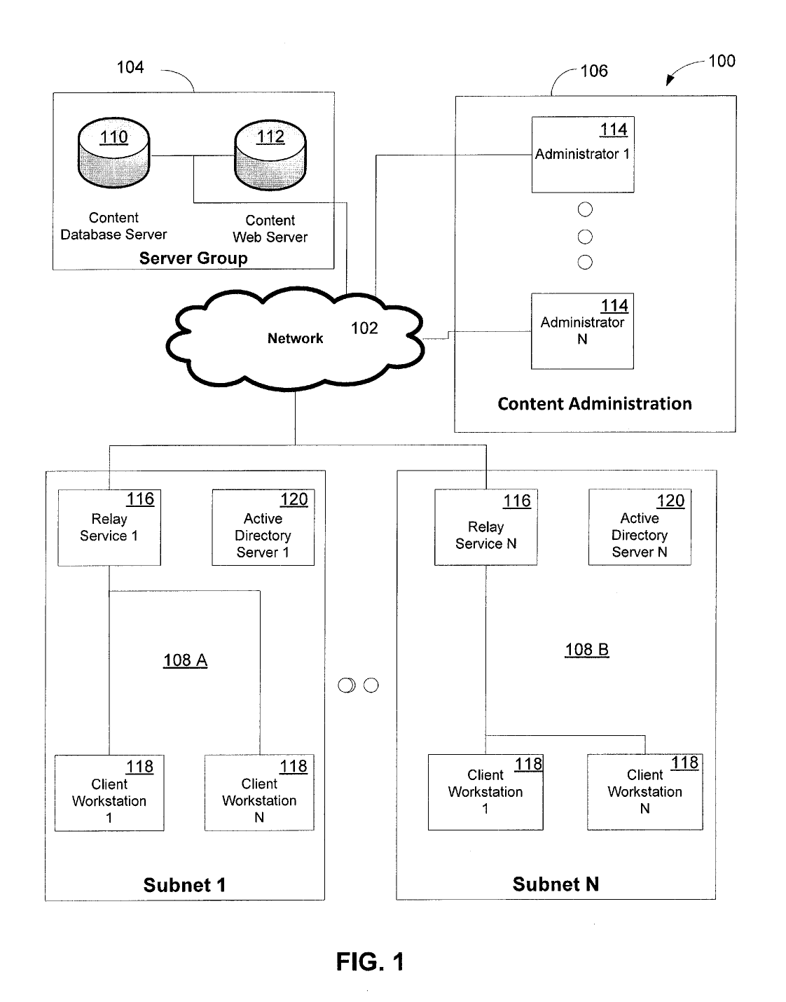

With reference to the drawings, an exemplary network environment or system in which the present invention may be implemented is presented in FIG. 1 and is designated as reference numeral 100. The system 100 may include a network 102, such as the Internet, a Local Area Network (LAN), Wide Area Network (WAN), wireless network or other similar configuration that allows communication among two or more computing devices. The present invention is described herein in the context of software modules.

As illustrated, in one embodiment of the present invention, the network 102 comprises groupings of modules that are interconnected and programmed to accomplish the objects of the invention. The groupings include a server group 104, a content administration group 106, and one or more subnet groups 108A, 108B collectively referenced as subnet 108. The server group 104 comprises a content database server 110 and may also include a content web server 112, collectively referenced as server (110, 112). The content administration group 106 includes one or more content administrator modules 114 (Administrator 1 through Administrator N). Each of the modules identified herein may further include other hardware and software components that may be adapted or otherwise utilized to meet the objectives of the present invention and are anticipated by the present invention.

The content administrator modules 114 define, provide, and distribute content that is to be displayed on target workstations. The content administrator modules 114 may reside on a central server or other client system, utilize the database server 110 to store pertinent content information and the web server 112 to present web content information. The content administrator modules 114 may store content slides that are published, in process, or archived, thereby providing a track/audit record. In one embodiment of the present invention, the administrator modules 114 enable an administrator to define and edit properties for the content slides such as name, description, designation as urgent, and specification that the content require acknowledgement from a viewing user. The modules 114 also allow the slides to be scheduled with automatic start/end times for automatic publish/unpublish. Groups of users to whom the slides would be published may also be specified within the administration modules 114.

The subnet groups 108 include a relay service 116, one or more client workstations 118 (Client workstation 1 through client workstation N), and may include an active directory server 120 wherein, users are assigned to one or more of a variety of groups. A user with access to the content web server 112 via the administrator module 114 can thereby create and distribute content to desired workstations 118 or users/user groups.

Subnet 108, as suggested by the name, is intended to represent subnet(s) of an organization's network 102 or other schemes implemented for security, network traffic segregation, or other purposes that provide logically or physically separated networks. An organization or department therewithin, may have one or more subnet groups 108. The relay service 116 of a particular subnet 108A, 108E provides communication to all of the workstations 118 within that subnet 108A, 108B. In effect the relay service 116 minimizes network traffic by providing intermediary services between the servers 110,112 and the workstations 118 within each subnet 108.

The relay service 116 caches any content that is distributed from the servers 110,112, by the content administrator module 114. Such caching may occur on the local computing device where the relay service 116 is installed or through other conventional caching techniques. Relay service 116 limits network bandwidth usage by eliminating the need for direct communications between workstations 118 and the servers 110,112. In one embodiment of the present invention, the relay service 116 utilizes dot net binary serialized objects to store relevant data items to the local computing device. In operation, the relay service 116 identifies whether new content from either the content server 110 or the web server 112 needs to be distributed to the workstations 118. Content can be provided to the relay service 116 via a push or pull mode of operation. The mode of operation is configurable at runtime and is set in the configuration of the relay service 116. In the push mode of operation, the relay service 116 operates as a listening device and waits for messages from the content administrator module 114. Conversely, in the pull mode of operation, the relay service 116 periodically makes requests (polls) to the content administrator modules 114 for new distributions. In the absence of a designation of a specific mode of operation, the system will operate in the push mode when the relay service 116 is exposed to the content administrator modules 114. The push mode involves less network traffic and provides better system performance. If the relay service 116 is not exposed to the content administrator module 114 then the pull mode is utilized.

In one embodiment of the present invention, when the relay service 116 is notified, or otherwise, discovers that there is new content that needs to be distributed, the relay service 116 makes a request to the content administrator modules 114 for the latest version of such content. The provided content is first cached by the relay service 116, and then a broadcast is made to all workstations 118 that are within the relevant subnet 108A, 108B, to notify them that new content is available. Such broadcast may be provided by utilizing User Datagram Protocol (UDP), and can be configured to be provided on any port to the workstations 118.

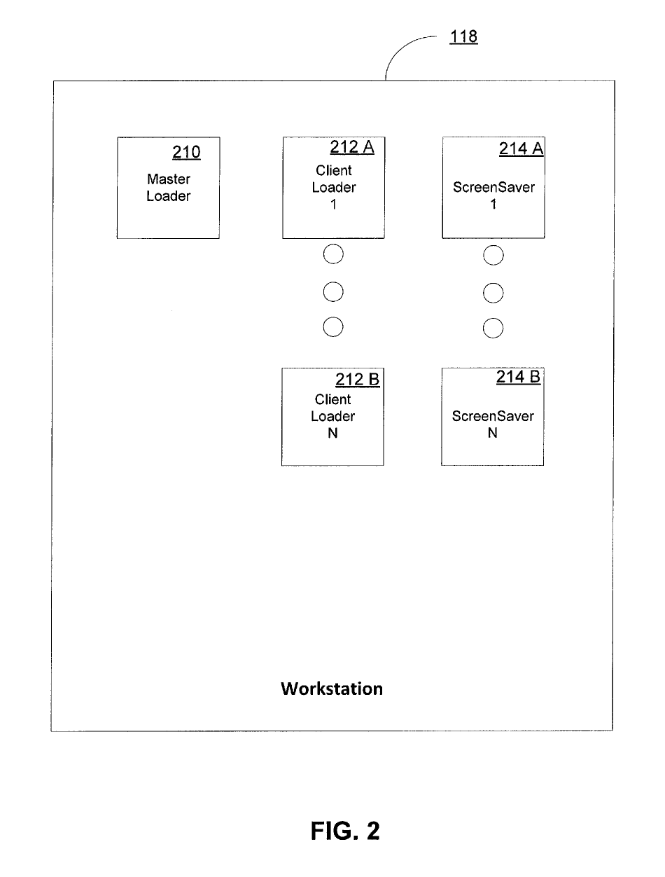

The components of the exemplary workstations 118 are best described with reference to FIG. 2. As illustrated, the workstation 118 comprise a master loader 210, one or more client loaders 212 (212A through 212B) and one or more screensavers 214 (214A through 214B). All three workstation components (210, 212, 214) communicate or otherwise provide indicia that facilitate the update and display of relevant distributed content from the centralized server (110, 112).

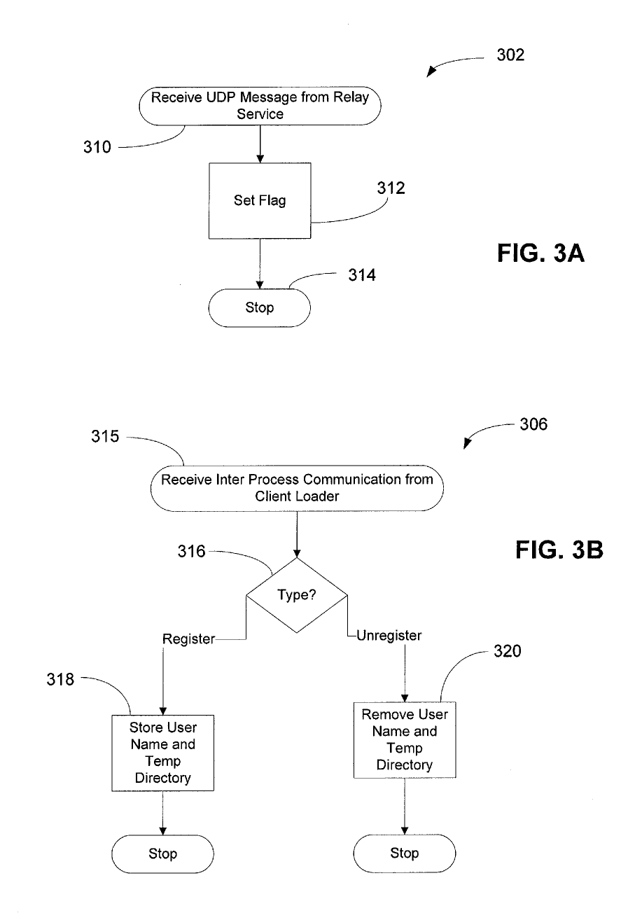

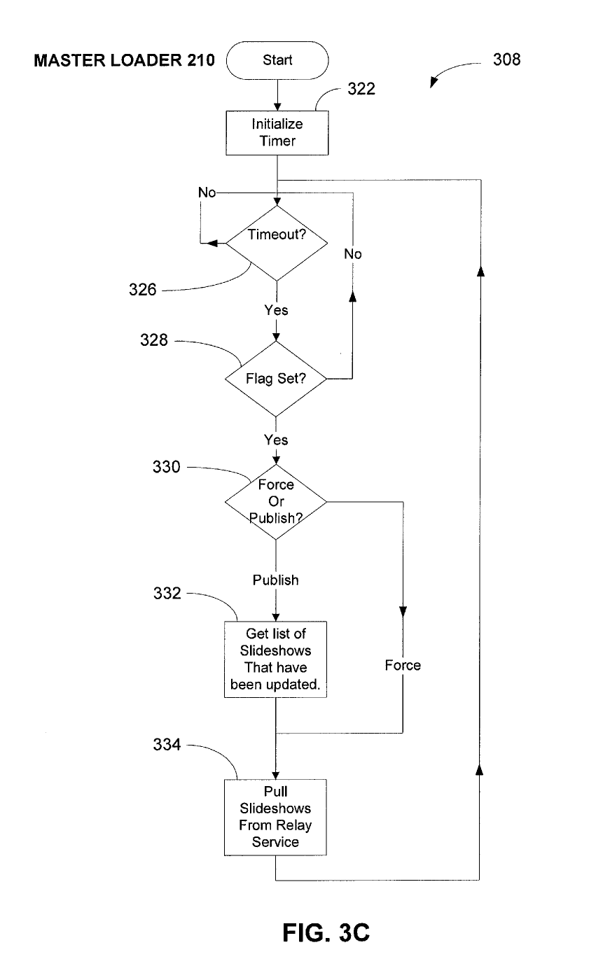

The operation of the components (210, 212, 214) of exemplary workstations 118 are best described with reference to the flow charts of FIGS. 3A, 3B, and 3C. In operation, the master loader 210 runs as a service on the client workstation device 118 and provides communications between the relay service 116, the one or more client loaders 212 and the screensavers 214. In one embodiment of the invention, the master loader 210 utilizes XML to store relevant data. In a further embodiment storage by the master loader 210 is via dot net binary serialized objects.

Turning initially to FIG. 3A, a flow chart of UDP message operation 302 is illustrated. At step 310, the master loader 210 receives a UDP message from relay service 116. An update flag is set at step 312, to indicate that pending content updates are present at or otherwise available at the relay service 116. The master loader 210 then exits this process flow at step 314. The update flag is later utilized by a separate module of the workstation 118 to acquire the updated content if it is relevant to the workstation or the logged on user.

Turning next to FIG. 3B, an inter process communication (IPC) message 306 between the master loader 210 and client loader 212 is illustrated. As shown at step 315 an IPC is received by the master loader 210 from the client loader 212. The message type is ascertained at step 316. There are two message types that can be communicated or otherwise processed between the client loader 212 and the master loader 210, namely a “register request” and an “unregister request”. In the case where the message type is a register request, a user name and a temporary directory for the user of the workstation 118 are stored by the master loader 210, at step 318. As an ordinary part of its operation, the master loader 210 maintains a list of all registered users. The list of users exists so that the master loader 210 can identify which users require content update.

Alternatively, when the message type is a request to unregister, the user related entry that was previously created in connection with the register request, is removed from the list that is maintained by the master loader 210, at step 320.

FIG. 3C illustrates logic flow 308 for the master loader 210. As shown, upon startup execution of the logic flow 308, a repeating first timer is initialized at step 322. At step 326, the timeout status of the first timer is evaluated. At step 328, the configured update behavior mode of the master loader 210 is evaluated following each timeout of the first timer. In other words, at step 328 a determination is made whether the master loader 210 is configured to force updates of content to the workstation 118 on each timeout, irrespective of the status of the update flag, or if the master loader 210 is configured to publish content update when flagged accordingly.

If the master loader 210 is configured to force updates of content on each timeout, execution proceeds to step 330, where information for all relevant slide shows/content is pulled from the relay service 116. Alternatively, if the master loader 210 is configured to publish updates of content, then at step 332 the system determines if the pending update flag is set. In the event that the update flag is not set, the master loader 210 loops back to continue checking the timeout status of the update first timer and execution is returned to step 326. If, on the other hand, the update flag is set then the system obtains a list or other identifying means, of content/slide shows that have been updated, at step 332. Utilizing the list of updated content/slide shows, the system pulls the relevant updates from the relay service 116, at step 334. After the content/slide shows are obtained, the master loader 210 distributes the content to the users that were registered via the previously described process 306 of FIG. 3B. It should be noted that since content may be distributed to specific active directory groups, content is only updated for the users that are members of relevant groups. Content may be stored locally in a temporary directory of the user's workstation or otherwise associated with the user in some other manner, such as being stored centrally and associated with the user's roaming server profile. In any case, the client loader module 212 which is executing on workstations 118, provides the necessary communications between the master loader 210 and the screensaver 214.

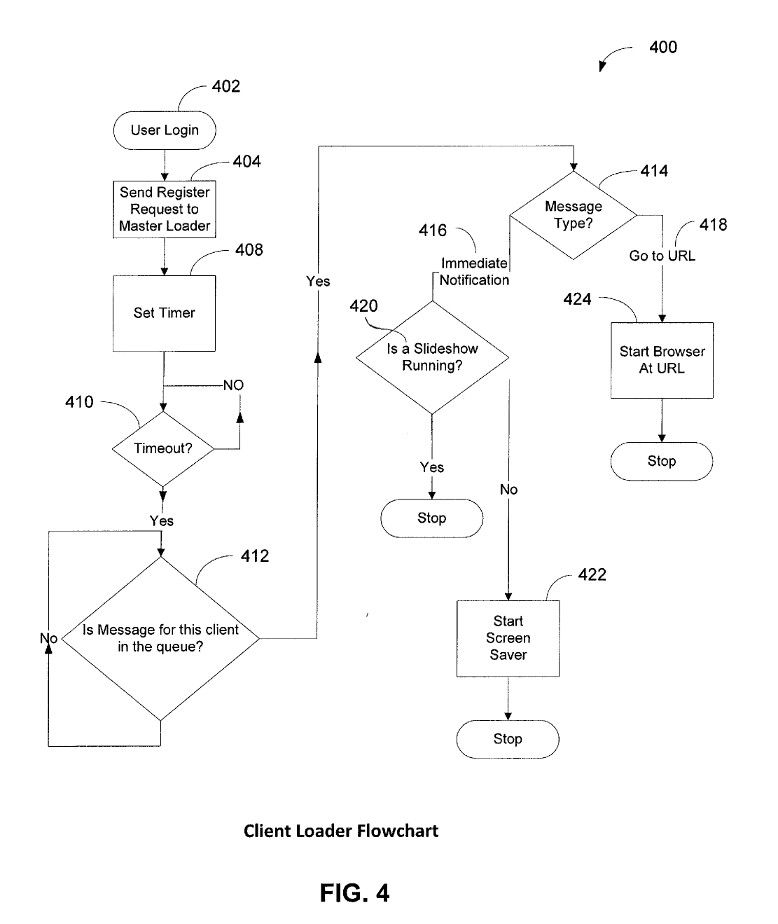

The client loader module 212 is best described with reference to FIG. 4 and the flow chart 400 illustrated therein. When a user first logs into one of the workstations 118, the client loader 212 begins execution as shown at step 402. The client loader 212 registers itself and essentially the user, with the master loader 210, at step 404. The client loader 212 also unregisters itself when the user logs out. Following registration, a repeating client timer is initiated at step 408. The client timer includes a runtime configurable interval. The timeout status of the client timer is evaluated at step 410. The timeout of the client timer enables further processing by the client loader module 212. In other words, operations of the client loader 212 remain suspended while the client timer remains timing. Upon timeout of the client timer, the process checks at step 412 for any new messages in a message queue. The message queue is specifically designated for each client loader 212 session. In the event that there are no messages, execution loops back to step 410 to await the next timeout.

If a message exists in the queue, the message type must first be determined, at step 414. In the preferred embodiment of the present invention, there are two message types that are handled by client loader 212, namely “immediate notification” 416 and “universal resource locator (URL) message” 418. These messages are sent by the master loader 210 and screensaver 214, respectively.

If the message type is an “immediate notification” 416, processing proceeds to step 420, where a determination is made whether a slide show or other content display is currently being executed, i.e., whether the screensaver module 214 is currently executing. If the screensaver 214 is not executing, then screensaver 214 is launched at step 422, to thereby immediately display the content associated with said notification.

If the message type is URL message 418, the message is deemed as a request from the screensaver 214 to launch a default browser on workstations 118. The browser is launched at the URL specified by the message 418, as shown at step 424. In other words, a URL is defined by the screensaver within the message 418 and the browser is directed by the client loader 212 to make a request to that URL. In effect, the webpage/content associated with the URL is displayed in a browser when the image is clicked at the workstations 118.

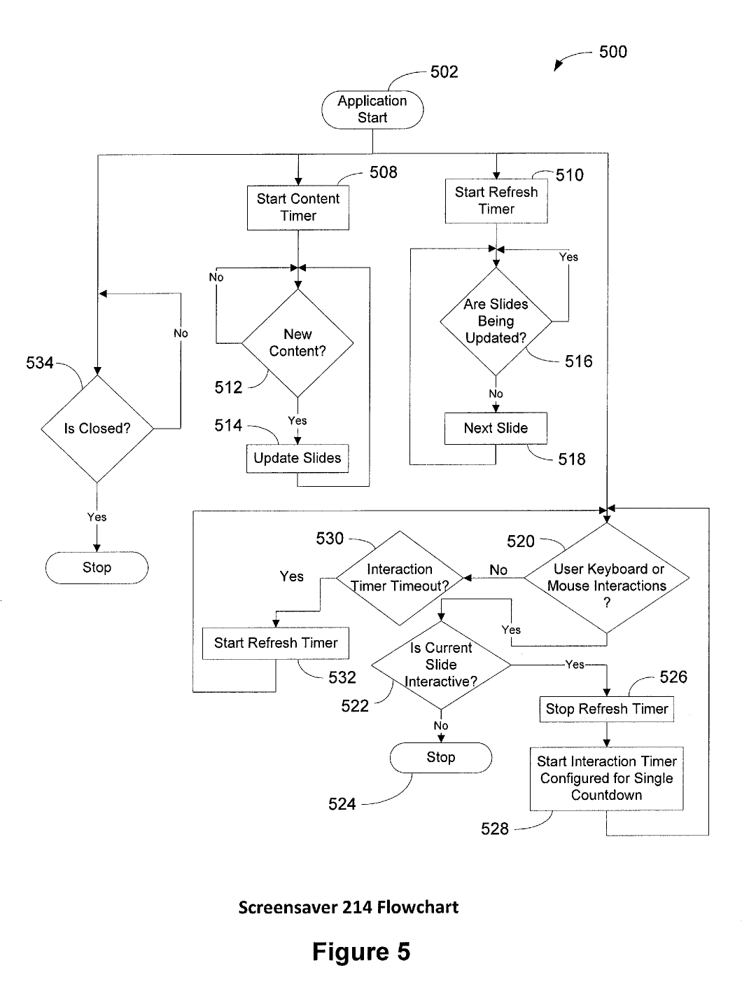

The detailed operations of the screensaver module 214 are best described with reference to the flow chart 500 of FIG. 5. Generally, the screensaver 214 displays to individual users, content that is distributed by the content administrator module 106 in the form of slide shows, webpages, images, or other formats. Content types may be described as follows:
1. Image—most slides will typically be of this type. The end user can view the slide, and if they click or move the mouse, the screensaver closes;
2. Web Page—this feature enables any webpage to be displayed in a slide in. In addition, if the page has a form, the user can fill it in and submit it;
3. Text—this type just contains text; and
4. Clickable Image—this is just like an image slide except that the user can click on the image to initiate some action, e.g., a webpage can be displayed in a browser.

Step 502 indicates the starting point of the process implemented by one embodiment of the screensaver 214. Subsequent processing steps are executed when workstations 118 remain idle for a pre-configured period of time. When screensaver 214 is active, it displays content on all monitors connected to workstations 118, and prevents the user from performing normal operations on the workstation. Normal operations can only be resumed by a user after appropriately interacting with screensaver 214. In some instances, such interaction may be as simple as a key press (similar to traditional screensavers), or as involved as providing some authentication information and/or more detailed user acknowledgement of the displayed content or slide. In one aspect for example, an “acknowledge property” may be set for a screensaver slide deck, thereby causing an acknowledge button to be displayed for each slide that is shown. As each slide is acknowledged by the user, the time and date of the acknowledgment is provided to the content server. In a further aspect, once a user has acknowledged a slide, there is no further prompt for acknowledgement unless the slide is republished. This aspect would be beneficial in situations where users must acknowledge changes in procedures, forms, etc. Reports of acknowledgments may then be generated from the system to evidence compliance, document user actions, or otherwise track other relevant data.

In an embodiment of the present invention, screensaver 214 utilizes data that is stored utilizing dot net binary serialized objects on workstations 118 for providing the displayed content. Other data access or usage modes would be apparent to those skilled in the art and such modes are contemplated and within the scope of the present invention. The detailed steps in an exemplary operation of screensaver 214 are described in the following discussions.

When screensaver 214 begins execution, two repeating timers namely, content timer (not shown) and refresh timer (not shown), are started at steps 508 and 510, respectively. Each of the timers 504, 506 notifies screensaver 214 upon a timeout event and thus initiates further processing steps. Specifically, upon the timeout of content timer, a determination is made at step 512 about the presence of new content for screensaver 214. If there is no new content, the process of screensaver 214 waits for the next timeout of the content timer. Conversely, if there is new content as determined at step 512, then the process advances to step 514. At step 514, the relevant content/slides are updated. Following the update, processing is transferred back to step 512 to await another timeout of the content timer. In operation, the presence of new content may be determined by checking for the availability of data in the user's temporary directory or for any other indication that the master loader 210 has updated content, as described earlier. If new content is available, that new content is utilized and the screensaver 214 generates and stores a timestamp along with other metadata to indicate and memorialize such last successful content update.

Upon the timeout event of the refresh timer, the process determines if slides are currently being updated, at step 516. If slides are being updated, the process is placed in a delay loop at step 516 to wait for the next timeout of the refresh timer, whereupon the slide update condition is reexamined. Alternatively, if slides are not being updated, processing passes on to step 518, where the next slide in the series is displayed. Next, processing is transferred back to step 516 to wait for the next timeout of the refresh timer. In effect, the refresh timer is responsible for moving from one content slide to the next content slide when there are no ongoing slide updates. Conversely, when updates are being made to the currently available content, the next slide is not shown until all updates are complete.

During execution, screensaver 214 is also constantly looking for any keyboard, mouse or other user interaction, as shown at step 520. If there is no user interaction, the process merely continues with its other operations, i.e., waiting on the content timer, refresh timer or application termination. On the other hand, if there is user interaction, the process determines if the currently displayed slide or content is interactive, at step 522. If the current display/slide is not interactive, meaning it is somewhat similar to a traditional screensaver, then the screensaver application terminates. If however, the current display/slide is interactive, the process stops the refresh timer, at step 526. An interaction timer 528 is initiated at step 530 and the interactive mode of screensaver 214 is enabled. Interaction timer 528 avoids a situation where the system is locked in a cycle of waiting for a user's interaction. When in interactive mode, the user is able to interact with the current slide. Importantly, the interaction timer 528 is configured for a single countdown rather than repeated countdowns. Once the countdown is completed, i.e., after the timeout of interaction timer 528, processing returns to waiting for user interaction at step 520, where the whole process is repeated. In operation, in the interactive mode, each time the user performs an action, the interaction timer 528 restarts, thereby allowing the user to continue interacting with the current slide. If no actions are performed and interaction timer 528 times out, as determined at step 530, the refresh timer is then started, at step 532. The restart of the refresher timer enables the next slide to be displayed as earlier described in reference to steps 516 through 518. When screensaver 214 terminates, the processing execution also terminates, as shown at step 534.

As would be appreciated by one skilled in the art, the described software modules may be individually or collectively implemented on single or multiple computing devices, and such computing devices may be co-located or otherwise dispersed across the network 102. Such implementations and arrangements achieve the objectives of the present invention and are contemplated and within the scope of the present invention.

Having described the system and method of the present invention and an embodiment thereof, an exemplary computer environment for implementing the described design and execution is presented next.

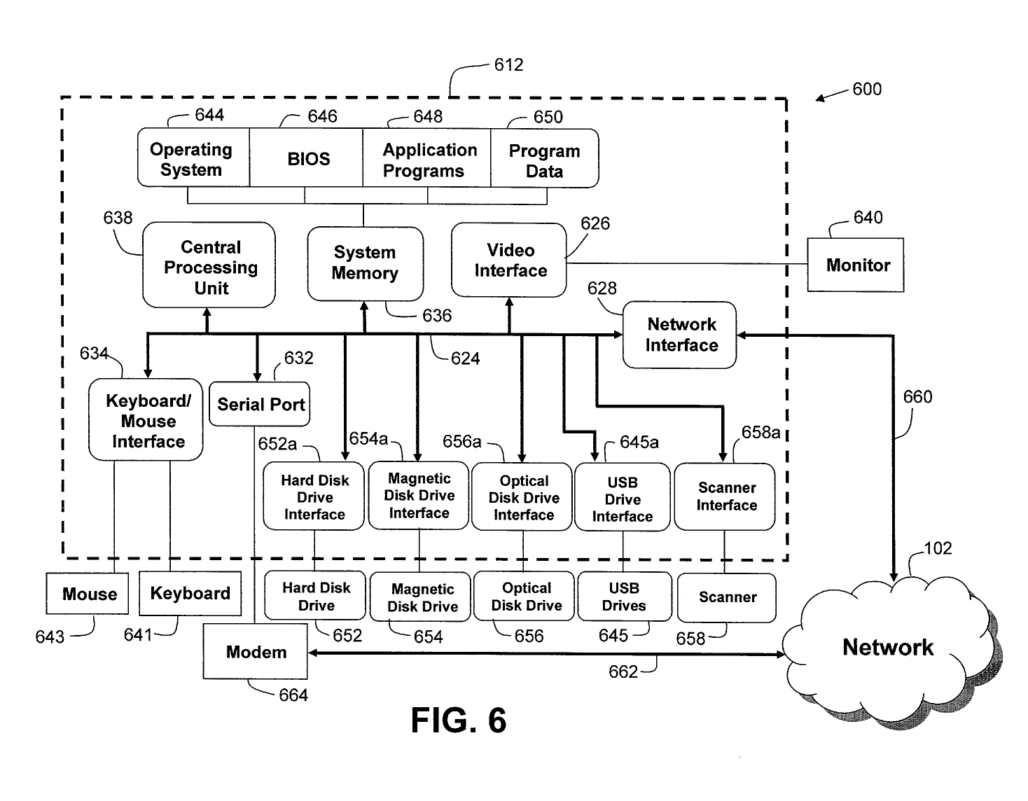

FIG. 6 illustrates an exemplary computing environment 600 that can be used to implement any of the processing thus far described. As shown, computer 612 may be a personal computer including a system bus 624 that couples a video interface 626, network interface 628, one or more serial ports 632, a keyboard/mouse interface 634, and a system memory 636 to a Central Processing Unit (CPU) 638. A monitor or display 640 is connected to bus 624 by video interface 626 and provides the user with a graphical user interface to interact with the system and method 100 of the present invention. The graphical user interface allows the user to enter commands and information into computer 612 using a keyboard 641 and a user interface selection device 643, such as a mouse or other pointing device. Keyboard 641 and user interface selection device are connected to bus 624 through keyboard/mouse interface 634. The display 640 and user interface selection device 643 are used in combination to form the graphical user interface which allows the user to implement at least a portion of the present invention. Other peripheral devices may be connected to remote computer through serial port 632 or universal serial bus (USB) drives 645 to transfer information to and from remote computer 612. For example, personal digital assistants (PDA) or other smart devices may be connected to computer 612 through serial port 632 or USB port 645a so that transaction information or other data may be downloaded to system memory 636 or another memory storage device associated with computer 612.

The system memory 636 is also connected to bus 624 and may include read only memory (ROM), random access memory (RAM), an operating system 644, a basic input/output system (BIOS) 646, application programs 648 and program data 650. Computer 612 may further include a hard disk drive 652 for reading from and writing to a hard disk, a magnetic disk drive 654 for reading from and writing to a removable magnetic disk (e.g., floppy disk), and an optical disk drive 656 for reading from and writing to a removable optical disk (e.g., CD ROM or other optical media). Computer 612 may also include USB drives 645 and other types of drives for reading from and writing to flash memory devices (e.g., compact flash, memory stick/PRO and DUO, SD card, multimedia card, smart media xD card), and a scanner 658 for scanning items such as still image photographs to be downloaded to computer 612. A hard disk interface 652a, magnetic disk drive interface 654a, an optical drive interface 656a, a USB interface 645a, and a scanner interface 658a operate to connect bus 624 to hard disk drive 652, magnetic disk drive 654, optical disk drive 656, USB drive 645 and a scanner 658, respectively. Each of these drive components and their associated computer-readable media may provide computer 612 with non-volatile storage of computer-readable instruction, program modules, data structures, application programs, an operating system, and other data for the computer 612. In addition, it will be understood that computer 612 may also utilize other types of computer-readable media in addition to those types set forth herein, such as digital video disks, random access memory, read only memory, other types of flash memory cards, magnetic cassettes, and the like.

Computer 612 may operate in a networked environment. Network interface 628 provides a communication path 660 between bus 624 and the network 102. It will be appreciated by one skilled in the art that the network connections shown herein are merely exemplary, and it is contemplated and within the scope of the present invention to use other types of network connections between computer 612 and any other computing devices including both wired and wireless connections.

From the foregoing, it will be seen that this invention is one well adapted to attain all the ends and objectives hereinabove set forth together with other advantages which are obvious and which are inherent to the method and apparatus. It will be understood that certain features and sub-combinations are of utility and may be employed without reference to other features and sub-combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirement.

While the invention has been described with reference to preferred embodiments, it will be understood by those skilled in the art that various changes may be made and equivalents may be substituted for elements thereof to adapt to specific situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed is:

1. A system for presenting screensaver content to client devices from a central system, the system comprising:
a content server having stored thereon the screensaver content;
one or more relay services; and
one or more workstations each having a display for presenting content to a user;
said workstations, relay services and content server in operable communication on a network; and
said one or more relay services in operable communication with said content server to receive the screensaver content and provide the screensaver content to said one or more workstations for display thereon.

2. The system of claim 1 further comprising an active directory group, wherein membership in said active directory group is utilized to control the screensaver content that is displayed at said one or more workstations.

3. The system of claim 1, wherein the screensaver content is displayed during the idle time of said one or more workstations based on a user configured timeout period that is specified in the operating environment of said one or more workstations.

4. The system of claim 3, wherein the screensaver content that is displayed on said one or more workstations is remotely enabled to immediately display on said one or more workstations thereby bypassing said timeout period of said one or more workstations' operating environment.

5. The system of claim 1 wherein the screensaver content includes information from a website.

6. The system of claim 1 wherein the screensaver content is operable for interaction by said user.

7. The system of claim 6 wherein the screensaver content includes an acknowledge button, whereby said user can signal to said content server the receipt of the screensaver content, whereby said content server can maintain and report an audit trail of users that have viewed the screensaver content.

8. The system of claim 6 wherein the screensaver content is an image slide that said user can click on or otherwise provide an indicia, to thereby launch a website target that was previously specified to said content server in association with said image slide.

9. The system of claim 6 wherein the screensaver content is webserver content that is displayed under the control of said content server.

10. The system of claim 1 wherein the screensaver content is a conversion of information that is prepared by a third party application program.

11. The system of claim 1 wherein the display duration of the screensaver content on said one or more workstations is controlled from a single central location.

12. In a system including a remote content server and one or more workstations, a method for providing dynamic screensavers as content slides to users of the workstations, the method comprising:
providing on the remote content server, the content slides and means for specifying attributes for the publication and behavior of the content slides;
providing a relay service for receiving, storing and sourcing said attributes and the content slides, for a local network environment;
providing a software module for the workstations for receiving on said local network, said published content slides, and the associated attributes;
utilizing said attributes on said one or more workstations to determine, based on the currently logged on user, if the content slides would be displayed,
utilizing said attributes to further determine if the content slides are displayed following an idle period of the workstation or if such display will interrupt any applications that are executing on the workstation; and
utilizing said attributes to determine if the content slides would allow user interaction; and
processing such interaction to provide the content slides as dynamic screensavers to users of the one or more workstations.

13. A method for providing screensaver content from a central computing device to a network, the method comprising:
providing a content administration module for creating and distributing the screensaver content, wherein said content administration module resides on a content server, said content server comprising a webserver and a database; and
providing a relay service for communicating between said content server and a local area network, said relay service receiving and caching the screensaver content from said content server for broadcast to said network.

14. The method of claim 13 further comprising providing a client computing device having a workstation module executing thereon, the workstation module receiving said broadcast from said network and providing the screensaver content to the user of said client computing device.

15. The method of claim 14 wherein said workstation module comprises:
a master loader;
a client loader for communicating with said master loader; and
a screensaver;
said master loader adapted to communicate between said relay service, said client loader and said screensaver;
wherein said master loader communicates with said relay service to update the screensaver content on said client computing device, wherein said master loader is in operable communication with said client loader to register or unregister a user associated with said client loader, and wherein said master loader distributes content to said registered user;
said client loader starting when a user logs onto said client computing device and registering itself with said master loader to thereby process messages received from said master loader and said screensaver.

16. The method of claim 15 wherein said client loader displays said screensaver or launches an instance of said screensaver upon receiving an immediate notification message for the screensaver content from said master loader, or said client loader launching a web browser when a message from said screensaver defines a universal resource locator.

17. The method of claim 16 wherein said client loader unregisters itself from said master loader when said user logs off.

18. The method of claim 15 further comprising said screensaver displaying the screensaver content, checking for updated screensaver content or advancing screensaver content slides, and processing user interaction with screensaver content.

19. The method of claim 15 further comprising said screensaver being executed following a predetermined client computing device idle period or being immediately executed when an immediate notification type screensaver content is received.

20. The method of claim 14 further comprising utilizing membership in an active directory group to control the screensaver content, and determine which users will be presented with the screensaver content.

21. The method of claim 20 wherein the screensaver content includes webpage information.

22. The method of claim 20 wherein said screensaver is interactive and in response to user interaction will provide a record of acknowledgement of the screensaver content.

23. A method in a computing environment for displaying a screensaver on a workstation, the method comprising:
defining one or more content slides on a separate computing device;
providing said one or more slides to a network;
receiving at the workstation from said network, said one or more content slides to be displayed as screensavers; and
wherein said one or more content slides are remotely updated at a device other than the workstation to thereby update the screensaver on the workstation.

24. The method of claim 23, wherein said one or more content slides that is displayed on the workstation is remotely enabled to immediately display on the workstation thereby bypassing a timeout period of the workstation's operating environment.

25. The method of claim 23 wherein said one or more content slides includes information from a website.

26. The method of claim 23 wherein said one or more content slides is operable for end user interaction.

27. The method of claim 23 wherein said one or more content slides includes an acknowledge button, whereby an end user of the workstation can signal to a remote computing device the receipt of said one or more content slides to thereby enable maintenance and reporting of an audit trail of users that have viewed the screensaver.

28. The method of claim 23 wherein said one or more content slides are each an image slide that a user can click on or otherwise provide an indicia, to thereby launch a website target that was previously specified in association with said image slide.

29. The method of claim 23 wherein the display duration of the screensaver on the workstation is controlled from an external central location.
